(19) United States
(12) Patent Application Publication
(10) Pub. No.: US 2025/0285101 A1
(43) Pub. Date: Sep. 11, 2025

(54) METHOD AND APPARATUS FOR PROVIDING ORDERING INFORMATION USING DYNAMIC INFORMATION

(71) Applicant: ARCH SEOUL Co., Ltd., Seoul (KR)

(72) Inventors: Yumi CHOI, Seoul (KR); Kihwan SUNG, Seoul (KR); Kihwa KIM, Seoul (KR); Mingyu GHIM, Yongin (KR)

(21) Appl. No.: 18/963,601

(22) Filed: Nov. 28, 2024

(30) Foreign Application Priority Data
Mar. 7, 2024 (KR) 10-2024-0032867
May 2, 2024 (KR) 10-2024-0058559
Aug. 28, 2024 (KR) 10-2024-0115984

(51) Int. Cl. G06Q 20/32; G06Q 20/38; H04L 9/06

(52) U.S. Cl. CPC G06Q 20/3276; G06Q 20/3829; H04L 9/0618

(57) ABSTRACT

Proposed are a method and an apparatus for providing ordering information by using dynamic information. The method includes receiving a protocol request together with the dynamic information from a user terminal, extracting a ciphertext from the dynamic information, validating an effectiveness of the dynamic information on the basis of the ciphertext, and providing an address information of Internet resource corresponding to the dynamic information to the user terminal when the dynamic information is valid. The apparatus includes a processor, a memory for loading a computer program executed by the processor, and a storage for storing the computer program.

### CROSS REFERENCE TO RELATED APPLICATION

The present application claims priority to Korean Patent Application No. 10-2024-0032867, filed on Mar. 7, 2024, Korean Patent Application No. 10-2024-0058559, filed on May 2, 2024, and Korean Patent Application No. 10-2024-0115984, filed on Aug. 28, 2024, the entire contents of which are incorporated herein for all purposes by this reference.

### BACKGROUND

### Technical Field

The present disclosure relates to a method and an apparatus for providing ordering information by using dynamic information. More particularly, the present disclosure relates to a method and an apparatus for providing a temporary access path with respect to untact ordering information by using dynamic information that varies according to time or events.

### Description of the Related Art

With the spread of mobile devices such as smartphones and tablet computers, Internet services utilizing QR (Quick Response) codes or NFC (Near Field Communication) are gradually increasing.

The QR code is a way of displaying information by using an image in the form of a two-dimensional matrix. The QR code can store various information such as text, a uniform resource identifier (URI), a web page, an image, a video, sound data, and the like.

The user may obtain information stored in the QR code by photographing the QR code with a camera or reading the same with an optical recognition device. For example, the user can scan a printed QR code by using a mobile terminal and access a web page for a specific Internet service by using a URL address included in the scanned QR code.

NFC is an information transmission method that performs communication between electronic devices by using short-range radio frequencies. NFC operates at a short distance of less than 10 cm, and has the characteristics of two-way communication with low power consumption and fast connection speed, thereby being utilized in various fields such as mobile payments, transportation cards, access control, and data transmission.

A user can obtain NFC information stored in an NFC tag by bringing the user's mobile terminal close to the NFC tag. For example, the user can establish a communication channel between the mobile terminal and the NFC tag by contacting the mobile terminal with the NFC tag, read a URL address stored in the NFC tag through the communication channel and, by using the information, access a web page for a specific Internet service.

Meanwhile, when using QR codes or NFC information to provide Internet services, it is necessary to update the QR codes and/or NFC information every hour, every situation, or at a specific cycle.

For example, when a target customer of a service changes, such as when a customer seated at a specific table in a cafe changes, the existing QR code can be replaced with a new QR code and ordering information (e.g., information or resources required to provide a service) can be accessed only through the new QR code, or the existing NFC information can be replaced with a new NFC information and ordering information can be accessed only through the new NFC information.

This has an advantage of preventing a third party other than a target customer of a service from accessing ordering information, but it also has several problems. For example, in order to change a QR code or NFC information, it is necessary to transmit the changed QR code and/or NFC information in real time from a relay device to an ordering terminal at each table (e.g., an ordering terminal displaying a QR code, or an NFC tag terminal transmitting a NFC information), but when a problem with a network connection occurs between the relay device and the ordering terminal, the information cannot be changed immediately, thereby causing a problem of delayed service provision.

In addition, there is a problem of requiring multiple relay devices or a high-end relay device in order to cover all of them when there are a number of ordering terminals placed in a store.

### SUMMARY

A technical problem to be solved through the present disclosure is to provide a method and an apparatus for providing ordering information by using dynamic information that easily enables untact ordering by using an ordering terminal that provides a QR code or NFC information.

Another technical problem to be solved through the present disclosure is to provide an authentication means that varies according to each situation or condition without network connections with a relay device or without receiving new information updates from the relay device.

Another technical problem to be solved through the present disclosure is to provide a method and an apparatus for providing ordering information by using dynamic information that can reduce the cost required for system construction by not requiring a separate communication means (e.g., a gateway) for connecting an ordering terminal and a relay device.

Another technical problem to be solved through the present disclosure is to provide a method of providing dynamic information and a terminal therefor, which minimizes power consumption by temporarily activating the terminal only when the dynamic information is provided and by otherwise deactivating the terminal.

The technical tasks of the present disclosure may not be limited to the technical tasks mentioned above, and other technical tasks not mentioned will be clearly understood by those skilled in the art from the following description.

A method, to be performed by a computing apparatus, for providing ordering information by using dynamic information in order to solve the described technical tasks according to an exemplary embodiment of the present disclosure includes receiving a protocol request together with the dynamic information from a user terminal, extracting a ciphertext from the dynamic information, validating an effectiveness of the dynamic information on the basis of the ciphertext, and providing an address information of Internet resource corresponding to the dynamic information to the user terminal when the dynamic information is valid, wherein the user terminal obtains the dynamic information by scanning a QR code displayed on an ordering terminal or by communicating with the ordering terminal through NFC (Near Field Communication), transmits the protocol request to a location specified by a first URL (Uniform Resource Locator) of the dynamic information, and transmits a service request by using the address information of Internet resource provided by the service server in response to the protocol request, wherein the user terminal and the ordering terminal is configured as separate devices.

As an exemplary embodiment, the ordering terminal may be configured to generate the QR code independently of the service server in a state where there is no data communication with the service server.

An apparatus for providing dynamic information in order to solve the described technical tasks according to an exemplary embodiment of the present disclosure includes a processor, a memory for loading a computer program executed by the processor, and a storage for storing the computer program, wherein the computer program includes instructions for performing an operation of receiving a protocol request together with dynamic information from a user terminal, an operation of extracting a ciphertext from the dynamic information, an operation of validating an effectiveness of the dynamic information on the basis of the ciphertext, and an operation of providing an address information of Internet resource corresponding to the dynamic information to the user terminal when the dynamic information is valid.

An ordering terminal for providing a time-variable dynamic information in order to solve the described technical tasks according to an exemplary embodiment of the present disclosure includes a processor, a memory for loading a computer program executed by the processor, and a storage for storing the computer program, wherein the computer program includes instructions for performing an operation of generating dynamic information by combining a ciphertext generated on the basis of a time information with a first URL (Uniform Resource Locator), and an operation of generating a QR code on the basis of the dynamic information to display the generated QR code through a display unit or providing the dynamic information to a user terminal by communicating with the user terminal through NFC (Near Field Communication).

As an exemplary embodiment, the computer program may further include instructions for performing an operation of displaying a first screen including a predetermined character or image on the display during a first time interval, the first time interval including an activation interval where power is temporarily applied to the display for switching to a displaying of the first screen and a deactivation interval where the displaying of the first screen is maintained in a state where power is not applied to the display, an operation of obtaining the time information in response to a first event when the first event occurs after the first screen is displayed to generate the dynamic information on the basis of the time information, and an operation of switching the screen of the display to a second screen including the dynamic information, wherein power is supplied to the display during a second time interval in order to switch to the second screen.

According to the described exemplary embodiments of the present disclosure, it may be possible to easily request untact ordering by using dynamic information (i.e., QR codes or NFC information) provided by an ordering terminal, yet it may be possible to effectively prevent an unauthorized third party from accessing ordering information by using past dynamic information by allowing the dynamic information to vary according to each time, event, or condition.

In addition, an ordering terminal may by itself generate dynamic information that varies over time without relying on external devices, thereby providing dynamic information different from each other according to each time, event, or condition even when a network connection between the ordering terminal and a relay device is interrupted or the ordering terminal does not receive new dynamic information updates from the relay device.

In addition, there is no need for a gateway for connecting an ordering terminal to a relay device, such that the cost required for constructing an entire service system can be reduced and the maintenance of the system can be made easier.

In addition, according to an exemplary embodiment of the present disclosure, it may be possible to generate dynamic information by selecting ciphertexts corresponding to the current time after storing ciphertexts in memory in advance for a predetermined period of time, thereby providing dynamic information to be updated periodically/non-periodically without a network connection between an ordering terminal and a relay device, without receiving new dynamic information updates from the relay device, and without equipping the ordering terminal with a complex encryption module.

In addition, while normally displaying default guidance text steadily in order to help the uses of customers in a state where power is not consumed by maintaining a display deactivated, the display may temporarily be activated only in situations where providing dynamic information is required, thereby minimizing the power consumption of an ordering terminal and reducing the effort and cost required for a system maintenance.

In addition, the exemplary embodiments of the present disclosure may be utilized for untact ordering such as in stores, and in this case may periodically or aperiodically vary dynamic information for the untact ordering, thereby effectively preventing an unauthorized third-party from accessing ordering information, and safely and accurately receiving the untact ordering of customers in online/offline stores.

### BRIEF DESCRIPTION OF THE DRAWINGS

FIG. 1 is a view showing an entire system where a method for providing ordering information by using dynamic information is operated according to an exemplary embodiment of the present disclosure.

FIG. 2 is a block diagram exemplarily showing a detailed configuration of a service server 100 according to a first exemplary embodiment of the present disclosure.

FIG. 3 is a block diagram exemplarily showing a detailed configuration of an ordering terminal 200 according to a first exemplary embodiment of the present disclosure.

FIG. 4 is a view for additionally illustrating a detailed method for generating and validating an instant ciphertext according to a first exemplary embodiment of the present disclosure.

FIG. 5 is a view for illustrating the overall operation process of a method for providing ordering information by using dynamic information according to a first exemplary embodiment of the present disclosure.

FIG. 6 is a view for additionally illustrating an exemplary form of dynamic information according to a first exemplary embodiment of the present disclosure.

FIG. 7 is a view for additionally illustrating an exemplary form of an identification table according to a first exemplary embodiment of the present disclosure.

FIG. 8 is a flowchart showing a method for providing ordering information by using dynamic information according to a first exemplary embodiment of the present disclosure.

FIG. 9 is a block diagram exemplarily showing a detailed configuration of a service server 100 according to a second exemplary embodiment of the present disclosure.

FIG. 10 is a block diagram exemplarily showing a detailed configuration of an ordering terminal 200 according to a second exemplary embodiment of the present disclosure.

FIGS. 11 and 12 are views for additionally illustrating a method for providing ordering information by using dynamic information in detail according to a second exemplary embodiment of the present disclosure.

FIG. 13 is a view for additionally illustrating an exemplary form of dynamic information according to a second exemplary embodiment of the present disclosure.

FIG. 14 is a view for additionally illustrating an exemplary form of an identification table according to a second exemplary embodiment of the present disclosure.

FIG. 15 is a flowchart showing a method for providing ordering information by using dynamic information according to a second exemplary embodiment of the present disclosure.

FIG. 16 is a flowchart specifically illustrating a method for controlling an operation of a display by an ordering terminal 200 in order to display dynamic information.

FIGS. 17A and 17B are views showing exemplary screens where dynamic information is displayed on a display in the form of QR codes.

FIGS. 18A, 18B, and 18C are views showing various examples of a predefined starting point.

FIG. 19 is a block diagram exemplarily showing a hardware configuration of a computing apparatus used for implementing various exemplary embodiments of the present disclosure.

### DETAILED DESCRIPTION OF THE DISCLOSURE

Hereinafter, exemplary embodiments of the present disclosure will be described in detail with reference to the accompanying drawings. Advantages and features of the present disclosure and a method for achieving them will become apparent with reference to exemplary embodiments described below in detail together with the accompanying drawings. When adding reference numerals to components of each drawing, it should be noted that the same components have the same numerals as far as possible even when they are displayed in different drawings. In addition, in describing the present disclosure, the detailed description thereof will be omitted when it is determined that a detailed description of a related known configuration or function may obscure the gist of the present disclosure.

Unless otherwise defined, all terms (including technical and scientific terms) used in the present specification can be used in the meaning that can be commonly understood by those skilled in the art to which the present disclosure pertains. In addition, terms defined in commonly used dictionaries are not ideally or excessively interpreted unless clearly and specifically defined. The terms used in the present specification are for the purpose of describing exemplary embodiments and is not intended to limit the present disclosure. In the present specification, the singular form also includes the plural form unless specifically stated.

In addition, terms such as first, second, A, B, (a), and (b) may be used to describe components of the present disclosure. These terms are only intended to distinguish the component from other components, and the nature, order, or sequence of the components are not limited by the terms. When it is stated that a component is “connected”, “combined”, or “coupled” to another component, it should be understood that the component may be directly connected or coupled to the other component, but another component may also be “connected”, “combined” or “coupled” between each component.

In the present specification, dynamic information may refer to a QR code and/or NFC information that varies according to time, specific conditions, and/or specific events.

Meanwhile, in the following description, a method for providing ordering information by using dynamic information may be briefly referred to as the “method for providing ordering information”.

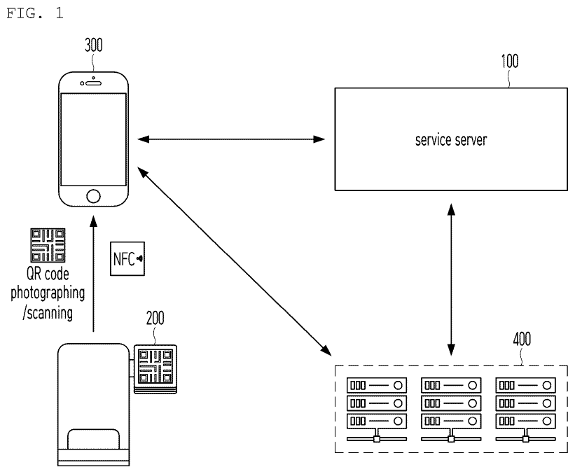

FIG. 1 is a view schematically showing an entire system where a method for providing ordering information by using dynamic information operates, and apparatuses constituting the same according to an exemplary embodiment of the present disclosure.

Referring to FIG. 1, the system may include a service server 100, an ordering terminal 200, a user terminal 300, and an Internet resource apparatus 400.

Meanwhile, herein in FIG. 1, the service server 100 and the Internet resource apparatus 400 may be illustrated as separate devices, but the scope of the present disclosure may not be limited thereto. For example, the service server 100 and the Internet resource apparatus 400 may be integrated into a single server apparatus.

The ordering terminal 200 may generate and provide dynamic information (e.g., a QR code or NFC information) that varies according to time, events, or situations. In this case, the ordering terminal 200 may update the dynamic information by newly generating dynamic information according to variation in time, events, or situations. For example, the ordering terminal 200 may update the dynamic information by newly regenerating the value of dynamic information every predetermined time period. Alternatively, the ordering terminal 200 may newly regenerate the value of dynamic information and may update the dynamic information in response to receiving a command event for requesting dynamic information updates. Alternatively, the ordering terminal 200 may newly regenerate the value of dynamic information and update the dynamic information, in response to identifying a situation where a customer enters a store or a customer is seated at a table.

When regenerating dynamic information according to time, events, or situations, the ordering terminal 200 may regenerate dynamic information on the basis of the current time at the time of regeneration.

As an exemplary embodiment, the ordering terminal 200 may obtain a timestamp of the current time from an internal timer, input the obtained timestamp and a secret key of the ordering terminal 200 into an encryption algorithm, and obtain a hash code as an output value thereof. Also, the ordering terminal 200 may generate an instant ciphertext from the obtained hash code according to a predetermined rule. The instant ciphertext may be a time-based one-time password.

At this time, the predetermined rule may be determined in various ways. For example, the predetermined rule may include generating the value of the hash code as an instant ciphertext as it is, generating the consecutive values thereof as an instant ciphertext after extracting a predetermined number of characters and/or numbers from the value of the hash code, or generating as an instant ciphertext the converted value after processing the hash code to convert the same into a predetermined number of numbers or characters.

The instant ciphertext generated in this way may have a time-variable value where the value varies whenever the timestamp of an input value varies. When the instant ciphertext is generated, the ordering terminal 200 may generate the dynamic information including the instant ciphertext in the form of a QR code and/or NFC information, and then may display the same on the display device of the ordering terminal 200 (e.g., an E-Paper display) or transmit the same to the user terminal 300 via an NFC tag.

In another exemplary embodiment, rather than directly generating an instant ciphertext by using an encryption algorithm, the ordering terminal 200 may store a plurality of pre-generated instant ciphertexts in the memory embedded in the ordering terminal 200. In this case, the ordering terminal 200 may obtain a timestamp of the current time from an internal timer, may generate in the form of QR code and/or NFC information the dynamic information including the selected instant ciphertext after selecting any one of the plurality of stored instant ciphertexts according to the timestamp of the current time, and may display the same on a display device (e.g., an E-Paper display) of the ordering terminal 200 or transmit the same to the user terminal 300 via an NFC tag.

As an exemplary embodiment, the ordering terminal 200 may store a first URL indicating a location of the service server 100 on the Internet network in a memory. When generating the dynamic information, the ordering terminal 200 may generate a QR code or NFC information by combining the generated or selected instant ciphertext with the first URL and provide the same as the dynamic information.

For example, when the first URL is “http://www.redirect.com” and a secret key is “cat”, the ordering terminal 200 may generate a one-time password (i.e., an instant ciphertext) “489523” on the basis of the secret key and timestamp, may generate the dynamic information of “http://www.redirect.com/489523” by combining the generated one-time password with the first URL, and may display the generated dynamic information as a QR code, or transmit the same to the user terminal 300 through NFC.

As another example, when the first URL is “http://www.redirect.com” and a device identification information is “489523”, the ordering terminal 200 may generate the dynamic information of “http://www.redirect.com/489523FFGGHH001001001” by combining the ciphertext (i.e., an instant ciphertext), “FFGH001001001”, including a timestamp and a salt value with the first URL and the device identification information, and may display the generated dynamic information as a QR code, or transmit the same to the user terminal 300 through NFC.

Herein, the secret key may be a value which is used as an input value of an encryption algorithm for generating an instant ciphertext, and may be an encryption key shared by the ordering terminal 200 and the service server 100 with each other.

In this case, the secret key may be a value uniquely assigned to each ordering terminal 200 or may be a value commonly used by a plurality of ordering terminals.

In addition, the device identification information may be also a value uniquely assigned to each ordering terminal 200, and may be a data value included in or combined with the dynamic information in order to indicate which ordering terminal 200 the dynamic information originates from.

The user terminal 300 may be a terminal used by a user intended to access ordering information, and may be, for example, a portable terminal carried by a customer seated at a store table. The user terminal 300 may obtain the dynamic information by photographing the QR code generated by the ordering terminal 200 with a camera or by contacting an NFC tag, and may transmit a protocol request to a location (i.e., a service server) specified by the first URL after reading the first URL included in the dynamic information.

Herein, the protocol request may be a HTTP (hypertext transfer protocol) or HTTPS (HTTP secure) request transmitted together with the dynamic information, and may be a request to provide resources, such as text, web pages, images, videos, sound data, and the like, to the first URL included in the dynamic information. Alternatively, the protocol request may be to execute by using a computer-readable command an operation of transmitting a message for requesting the production and the transportation of a product or the provision of a service to the first URL included in the dynamic information.

The user terminal 300 may receive the address information of Internet resource provided by the service server 100 in response to the protocol request, and transmit a service request to the location specified by the address information of Internet resource, that is, the Internet resource apparatus 400. Then, the user terminal 300 may receive and display the ordering information provided by the Internet resource apparatus in response to the service request, and may execute untact ordering for a product or service according to a user input. Meanwhile, in this case, the service server 100 and the Internet resource apparatus 400 may be implemented as a single server apparatus or may be implemented as separate server apparatus.

As an exemplary embodiment, the user terminal 300 may be a computing apparatus capable of communicating with the service server 100, and may be, for example, any one of a smartphone, a mobile phone, a navigation device, a computer, a laptop computer, a digital broadcasting terminal, a personal digital assistant (PDA), a portable multimedia player (PMP), and/or a tablet PC, but is not limited thereto. For example, any device among terminal devices having a data communication function may be the user terminal 300. In addition, the user terminal 300 may have a program or application installed in advance for performing the method for providing ordering information by using dynamic information, may receive the dynamic information provided by the server 100 for providing the ordering information through the program or application, and may support QR code photographing by the user's manipulation or NFC communication functions.

The service server 100 may receive a protocol request from the user terminal 300, and provide the user terminal 300 with the address information of Internet resource for accessing the Internet resource apparatus 400 when the protocol request is valid after validating the effectiveness of the protocol request. The address information of Internet resource may include a second URL indicating a location of the Internet resource apparatus 400 on the Internet network.

As an exemplary embodiment, the service server 100 may validate the effectiveness of the dynamic information transmitted together with the protocol request in order to validate the effectiveness of the protocol request. Depending on the result of the effectiveness validation, the service server 100 may selectively provide the address information of Internet resource to the user terminal 300. For example, when it is determined that the dynamic information is valid as the result of the effectiveness validation, the service server 100 may provide the user terminal 300 with the address information of Internet resource. Otherwise, when it is determined that the dynamic information is invalid as a result of the effectiveness validation, the service server 100 may reject the protocol request of the user terminal 300 and may not provide the address information of Internet resource to the user terminal 300.

The Internet resource apparatus 400 may an apparatus for storing resources such as text, web pages, images, videos, sound data, and the like, and may process a service request which the user terminal 300 transmits through the address information of Internet resource. For example, when the user terminal 300 transmits a service request, the Internet resource apparatus 400 may process a task according to the corresponding request and may provide the processed result and/or the held resource to the user terminal 300. The result or resource the Internet resource apparatus 400 provides to the user terminal 300 may include information on a product or service provided by a store, and/or a web page for processing the user's untact ordering, and the like.

As an exemplary embodiment, the Internet resource apparatus 400 may process a task accordingly only when the service request is valid after validating the effectiveness of the service request of the user terminal 300. In this case, validating the effectiveness of the service request may be performed by validating the effectiveness of a session key presented together with the service request by the user terminal 300. For example, when the session key presented by the user terminal 300 is valid, the Internet resource apparatus 400 may view the corresponding service request as valid and process the task according to the request to provide the processed result, but when the session key presented by the user terminal 300 is not valid, may view the service request as invalid and reject the corresponding service request.

Meanwhile, as mentioned before, the service server 100 and the Internet resource apparatus 400 may be implemented as a single server apparatus. In this case, the Internet resource apparatus 400 may be one or more hardware modules and/or software modules included in the service server 100, and the functions of the Internet resource apparatus 400 described above may be performed by the service server 100.

For example, the service server 100 may perform a function of receiving a service request transmitted through the address information of Internet resource by the user terminal 300, a function of validating the effectiveness of the service request by using a session key, and/or a function of processing a corresponding task to provide the processed result to the user terminal 300 when the service request is valid. Meanwhile, although not shown in the drawing, each apparatus 100, 200, 300, 400 may be wiredly or wirelessly connected to each other through a communication network (not shown). For example, depending on the installation environment, the communication network may be composed of a wired network such as Ethernet, a wired home network (Power Line Communication), a telephone line communication device, and RS-serial communication, a wireless network such as a mobile communication network, a wireless LAN (WLAN), Wi-Fi, Bluetooth, and ZigBee, or a combination thereof.

According to the system shown in FIG. 1, the ordering terminal 200 may generate the dynamic information updated according to time, events, or situations through its own embedded module even in a state where there is no communication connection with the service server 100. Accordingly, even without receiving the dynamic information updates from the service server 100, the ordering terminal 200 may by itself update and/or provide the dynamic information of different values, thereby preventing an unauthorized third party from accessing the ordering information by using the past dynamic information.

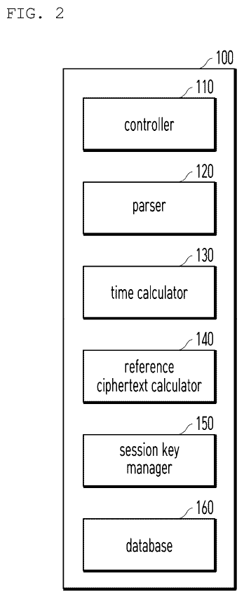

FIGS. 2 to 8 may describe a method and an apparatus for providing ordering information by using dynamic information according to a first exemplary embodiment of the present disclosure.

In the first exemplary embodiment, the service server 100 may share and store each secret key of a plurality of the ordering terminals 100 managed by itself in advance, and perform as a single process to validate the effectiveness of the dynamic information by using the secret key and to identify the ordering terminal that provides the dynamic information.

For example, suppose that an offline store is equipped with 10 ordering terminals, and the secret key of the first ordering terminal among them is “cat”. In this case, the secret key “cat” may be shared in advance with the service server 100. Then, the first ordering terminal may generate an instant ciphertext by using the secret key “cat” and transmit a protocol request including the same to the service server 100. In response to the transmitted protocol request, the service server 100 may generate reference ciphertexts corresponding to each secret key stored in the service server 100, that is, each secret key of 10 ordering terminals, and may determine whether any of the generated reference ciphertexts matches (or corresponds) the instant ciphertext.

Specifically, the service server 100 may identify the dynamic information from a protocol request, and then extract an instant ciphertext from the dynamic information. Then, the service server 100 may obtain a timestamp of the current time from a timer provided inside the service server 100, may input the obtained timestamp and a pre-shared secret key into an encryption algorithm, and obtain a hash code as an output value thereof. Then, a reference ciphertext may be obtained from the obtained hash code according to a predetermined rule. This operation may be performed for each of the stored secret keys, and a plurality of reference ciphertexts corresponding to each secret key may be obtained. Also, the service server 100 may compare the plurality of reference ciphertexts and instant ciphertexts with each other, and determine that the dynamic information is valid when a reference ciphertext matches (or corresponds) the instant ciphertext, otherwise determine that the dynamic information is invalid. In this case, the encryption algorithm used to obtain the reference ciphertext and the predetermined rule may be the same as the encryption algorithm and the predetermined rule used for the ordering terminal 200 to obtain the instant ciphertext.

In addition, when there is a reference ciphertext that matches (or corresponds)) an instant ciphertext, the service server 100 may identify which ordering terminal provides the dynamic information by checking which ordering terminal's secret key is used to generate the reference ciphertext.

FIG. 2 is a block diagram exemplarily showing a detailed configuration of a service server 100 according to a first exemplary embodiment of the present disclosure.

Referring to FIG. 2, the service server 100 may include a controller 110, a parser 120, a time calculator 130, a reference ciphertext calculator 140, a session key manager 150, and/or a database 160. Some components 110, 120, 130, 140, 150 of the service server 100 shown in FIG. 2 may be software modules, but are not limited thereto.

The controller 110 may control the overall operations of the service server 100. For example, the controller 110 may control the calling and operation of functions for driving other components 120, 130, 140, 150, 160 of the service server 100, or may control the operations of various components included in the service server 100, such as a CPU, a memory, a communication device, etc.

The parser 120 may identify the dynamic information from a protocol request of the user terminal 300 and extract an instant ciphertext from the identified dynamic information. The extracted instant ciphertext may be provided to the reference ciphertext calculator 140.

The time calculator 130 may calculate a timestamp of the current time by using a timer embedded in the service server 100.

As an exemplary embodiment, the time calculator 130 may be configured to calculate a timestamp that varies according to each time interval on the basis of a predetermined time interval. For example, when the predetermined time interval is seconds, the time calculator 130 may calculate a timestamp having a different value for each time interval of 5 seconds.

The reference ciphertext calculator 140 may generate at least one reference ciphertext on the basis of a pre-shared secret key and a timestamp provided by the time calculator 130 and validate the effectiveness of an instant ciphertext by checking whether there is a reference ciphertext, which matches (or corresponds) the instant ciphertext extracted from the parser 120, among the at least one ciphertext. The reference ciphertext calculator 140 may determine that the instant ciphertext (or a protocol request) is valid when the reference ciphertext and the instant ciphertext match each other, otherwise determine that the instant ciphertext (or a protocol request) is invalid.

Meanwhile, it may be possible to prevent a third party from accessing the service server 100 by using the past dynamic information stored in advance because the reference ciphertext is calculated by using a timestamp of the current time. That is, the instant ciphertext included in the past dynamic information may be generated on the basis of the past timestamp and may not match the reference ciphertext based on the timestamp of the current time, thereby rejecting a request based on the past dynamic information assuming as an abnormal request.

As an exemplary embodiment, when the reference ciphertext and the instant ciphertext do not match, the reference ciphertext calculator 140 may calculate a sub-reference ciphertext on the basis of the timestamp of the just-before time interval, and determine that an instant ciphertext (or a protocol request) is valid when both match after comparing the sub-reference ciphertext with the instant ciphertext.

This may be to complement the problem that even a normal request is determined to be invalid when the time point, at which a protocol request is received from the user terminal 300, is on the boundary of each time interval. That is, when the predetermined time interval is 5 seconds, the ordering terminal 200 may generate the dynamic information at 12:00:05 seconds, and when the time becomes 12:00:06 while the user terminal 100 obtains the dynamic information and transmits a protocol request, the timestamp used to generate an instant ciphertext may be the timestamp between 12:00:00 and 12:00:05 seconds, and the timestamp used to generate a reference ciphertext may be the timestamp between 12:00:06 and 12:00:10 seconds, so that the two may be different from each other. In this case, there may be a problem that even a normal request may be rejected, so when validating the effectiveness, the instant ciphertext may be first compared with the reference ciphertext, and when the two do not match, the instant ciphertext may be secondarily compared with the sub-reference ciphertext, thereby complementing a determination error when the protocol request is at the boundary of a time interval.

The session key manager 150 may generate or determine and provide a session key. The session key may be a key required to access the Internet resource apparatus 400 to receive a service, and when a correct session key is not presented, the Internet resource apparatus 400 may reject the request assuming the corresponding request as an abnormal request.

As an exemplary embodiment, the session key manager 150 may generate or determine and provide a session key in various ways. For example, the session key manager 150 may determine and provide a one-time password extracted from the dynamic information as a session key as it is, may generate and provide a session key in real time in response to receiving a protocol request, or may select and provide any one of a plurality of predetermined session keys in a round robin method.

The database 160 may store an identification table including a plurality of pre-shared secret keys and a plurality of address information of Internet resource. The identification table may be used for the service server 100 to query the address information of Internet resource to be replied to the user terminal 300. For example, when receiving a protocol request from the user terminal 300, the service server 100 may calculate a plurality of reference ciphertexts corresponding to each of a plurality of secret keys in the identification table, referring to the identification table stored in the database 160, and of those may identify a reference ciphertext that corresponds to an instant ciphertext included in the protocol request. Also, the address information of Internet resource corresponding to the identified reference ciphertext, for example, located in the same row as the identified reference ciphertext, may be queried and provided to the user terminal 300 in response to the protocol request transmitted by the user terminal 300.

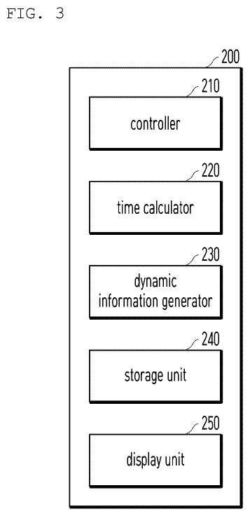

FIG. 3 is a block diagram exemplarily showing a detailed configuration of an ordering terminal 200 according to a first exemplary embodiment of the present disclosure.

Referring to FIG. 3, the ordering terminal 200 may include a controller 210, a time calculator 220, dynamic information generator 230, a storage unit 240, and/or a display unit 250. Some components 210, 220, 230 of the ordering terminal 200 shown in FIG. 3 may be software modules, but are not limited thereto.

The controller 210 may control the overall operation of the ordering terminal 200. For example, the controller 210 may control the calling and operation of functions for driving other components 220, 230, 240, 250 of the ordering terminal 200, or may control the operation of various components included in the ordering terminal 200, such as a CPU, a communication device, etc.

The time calculator 220 may calculate a timestamp of the current time by using a timer embedded in the ordering terminal 200. The detailed configuration and operation of the time calculator 220 may be substantially the same as the configuration and operation of the time calculator 130 described with reference to FIG. 2, so a detailed description thereof will be omitted here.

The dynamic information generator 230 may generate the dynamic information by combining a secret key of an ordering terminal 200, a timestamp provided by the time calculator 220, and a first URL, the address information where the service server 100 is located on the Internet network. In this case, the dynamic information may be generated in the form of a QR code or NFC information. The generated dynamic information may be provided to the display unit 250 to be displayed in the form of a QR code image, or may be transmitted to the user terminal 300 via an NFC tag (not shown).

The storage unit 240 may be a configuration for providing a data storage means for the ordering terminal 200 and, for example, may store a secret key of the ordering terminal 200 or may temporarily/non-temporarily store the dynamic information generated by the dynamic information generator 230.

The display unit 250 may be a configuration for externally displaying the dynamic information generated by the dynamic information generator 230 in the form of a QR code and, for example, may include any one of various display means, such as a liquid crystal display (LCD), a light emitting diode (LED), an organic light emitting diode (OLED), an E-PAPER, and the like.

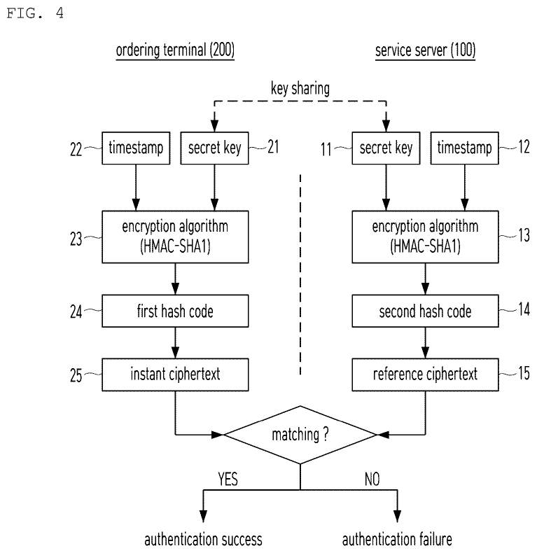

FIG. 4 is a view for additionally illustrating a detailed method for generating and validating an instant ciphertext according to a first exemplary embodiment of the present disclosure.

In an exemplary embodiment of FIG. 4, the ordering terminal 200 and the service server 100 may generate each ciphertext 15, 25 independently of each other except for the step of initially sharing a secret key. Hereinafter, a detailed description will be given with reference to the drawings.

The ordering terminal 200 and the service server 100 may share the same secret key with each other in order to generate the same ciphertext 15, 25 in the same time interval. Sharing the secret key may be performed through transmitting the secret key held by one of the ordering terminal 200 and the service server 100 to the other through a temporary communication connection, or in a way an administrator directly inputs the secret key to the ordering terminal 200 or the service server 100 by manipulating the ordering terminal 200 or the service server 100.

First, a method of generating an instant ciphertext 25 in the ordering terminal 200 will be described. The ordering terminal 200 may input the timestamp 22 obtained on the basis of the current time together with the previously shared secret key 21 as an input value to the encryption algorithm 23. Herein, as described above, the timestamp 22 may vary according to each time interval based on a predetermined time interval.

The encryption algorithm 23 may perform an encryption operation on the basis of the two inputted values 21, 22 and may output a first hash code 24 according to the inputted values 21, 22. The encryption algorithm 23 may be an algorithm based on a hash function, and may be, for example, HMAC-SHA1, but is not limited thereto.

When the first hash code 24 is obtained, the instant ciphertext 25 may be obtained according to a predetermined rule on the basis of that. The predetermined rule may be described in detail above, so a description thereof may be omitted here.

When the instant ciphertext 25 is generated in this way, the dynamic information may be generated by combining the instant ciphertext 25, the first URL, etc., and the user terminal 300 may transmit the dynamic information together with a protocol request to the service server 100. The service server 100 may extract the instant ciphertext 25 from the dynamic information in order to validate the effectiveness of the transmitted dynamic information, and may generate a reference ciphertext 15 corresponding to the secret key 11.

Specifically, the service server 100 may input the timestamp 12 obtained on the basis of the current time together with the previously shared secret key 11 as an input value to the encryption algorithm 13. Herein, the timestamp 12 may vary according to each time interval based on a predetermined time interval, and may be the same value as the timestamp 22.

The encryption algorithm 13 may perform an encryption operation on the basis of the two inputted values 11, 12 and may output a second hash code 14 according to the inputted values 11, 12. The encryption algorithm 13 may be the same as the encryption algorithm 23, and the inputted values 11, 12 and the encryption algorithm 13 used to calculate the second hash code 14 may be the same as those used to calculate the first hash code 24, such that the second hash code 14 has the same value as the first hash code 24.

When the second hash code 14 is obtained, the reference ciphertext 15 may be obtained according to the same predetermined rule as in the case of the first hash code 24. When the reference ciphertext 15 is obtained, the instant ciphertext 25 and the reference ciphertext 15 may be compared to see whether the two match each other and it may be determined that validating the effectiveness of the dynamic information is successful when matching or it may be determined that validating the effectiveness of the dynamic information is failed when not matching.

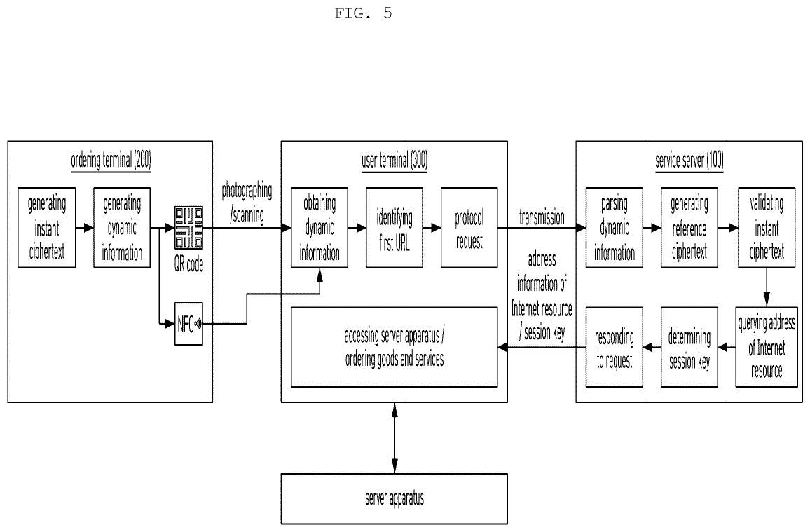

FIG. 5 is a view for illustrating the overall operation process of a method for providing ordering information by using dynamic information according to a first exemplary embodiment of the present disclosure. In the description of FIG. 5, the detailed description thereof will be omitted in order to avoid duplication of the description for the same contents as those described with reference to FIGS. 1 to 4.

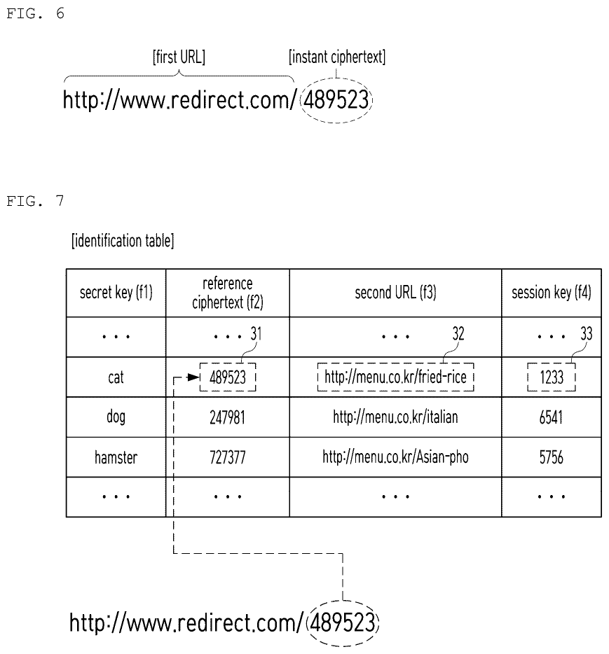

Referring to FIG. 5, an instant ciphertext may be generated in the ordering terminal 200, and the dynamic information may be generated on the basis of the instant ciphertext. Then, the ordering terminal 200 may generate a QR code or NFC information including the dynamic information on the basis of the generated dynamic information and provide the same to the user terminal 300. Meanwhile, an exemplary form of the dynamic information will be described with reference to FIG. 6.

FIG. 6 is an exemplary form of the dynamic information and shows that a first URL is combined with an instant ciphertext. Herein, the first URL may be an address of the service server 100 on the Internet network and may be an address where the user terminal 300 transmits a protocol request.

Referring back to FIG. 5, the user terminal 300 may obtain the dynamic information by photographing or scanning the QR code displayed on the ordering terminal 200 or receiving NFC information from the NFC tag of the ordering terminal 200. Then, the protocol request may be transmitted to the location (i.e., the service server) indicated by the first URL after identifying the first URL included in the dynamic information.

The service server 100 may receive a protocol request, identify the dynamic information therefrom, and then parse the same to extract an instant ciphertext. Then, the service server 100 may generate one or more reference ciphertexts on the basis of a pre-shared secret key list and timestamp, and validate the effectiveness of the instant ciphertext by comparing the one or more reference ciphertexts with the instant ciphertext.

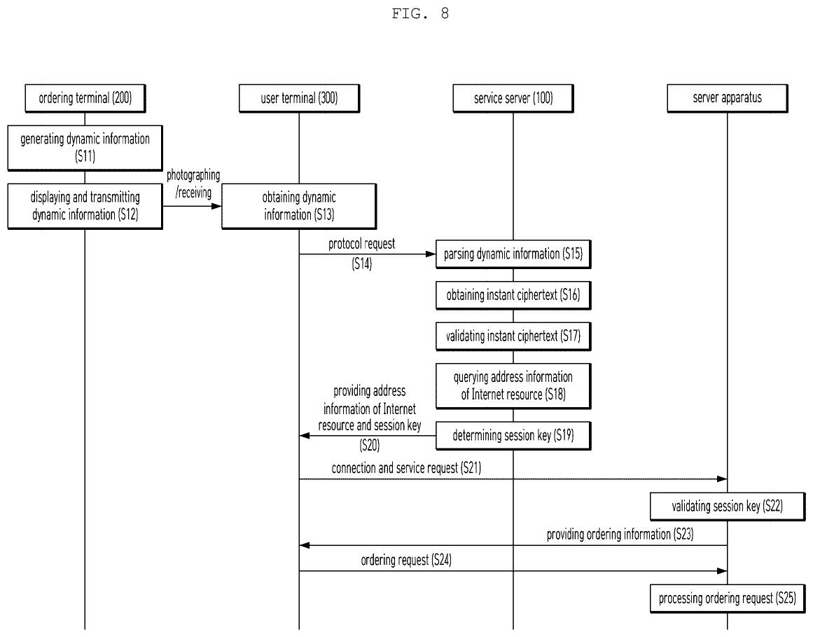

When the instant ciphertext is valid as a result of the validation, the service server 100 may query the address information of Internet resource and/or a session key corresponding to the instant ciphertext of the protocol request in the identification table, and may transmit the address information of Internet resource and/or the session key as a response to the protocol request. Meanwhile, an exemplary form of the identification table is described with reference to FIG. 7.

As an exemplary form of an identification table, FIG. 7 shows an example including a secret key field (f1), a reference ciphertext field (f2), a second URL field (f3), and a session key field (f4).

The secret key field (f1) may be a field where a secret key pre-shared with each ordering terminal is recorded, and each ordering terminal may have a unique secret key distinguished from other ordering terminals.

The reference ciphertext field (f2) may be a field where a reference ciphertext corresponding to each secret key is recorded. The reference ciphertext field (f2) may be a value that varies whenever a protocol request is received from the user terminal. For example, when a protocol request is received from the user terminal, a reference ciphertext corresponding to each secret key may be calculated on the basis of a timestamp value at that time, and then the value of the reference ciphertext field (f2) may be updated or assigned with that value.

The second URL field (f3) may be a field where a second URL indicating a location of the Internet resource apparatus 400 on the Internet network is recorded, and the second URL may indicate a web page address for receiving untact ordering of a store in which the ordering terminal 200 is installed.

The session key field (f4) may be a field where a session key for proving an access authorization of the Internet resource apparatus 400 is recorded, and the session key may be determined differently for each protocol request or for each time interval.

The service server 100 may query the second URL corresponding to the instant ciphertext by referring to the identification table on the basis of the instant ciphertext included in dynamic information. For example, the service server 100 may search for a row where a reference ciphertext 31 having the same value as the instant ciphertext (“489523”) identified from the dynamic information is located, query the second URL 32 in the searched row, and provide the queried second URL 32 to the user terminal as an address information of Internet resource which provides Internet resources related to the ordering information. In this case, the session key 33 queried in the corresponding row may be provided together as a session key corresponding to the second URL.

Meanwhile, in the exemplary embodiment of FIG. 7, the reference ciphertext field (f2) may be illustrated to be included in the identification table, but the scope of the present disclosure may not be limited thereto. For example, when receiving a protocol request, a reference ciphertext corresponding to each secret key in the secret key field (f1) may be calculated, but the calculated reference ciphertext may be only stored in a separate storage means (e.g., RAM) and may not be recorded in the identification table, and the present disclosure may operate through querying the second URL of the row, where the corresponding secret key is located, from the identification table after identifying the secret key corresponding to the corresponding reference ciphertext when there is a reference ciphertext that matches (or corresponds) the instant ciphertext, and providing the same as an address information of Internet resource. In this case, the identification table may not include the reference ciphertext field (f2).

In addition, in the exemplary embodiment of FIG. 7, the session key field (f4) may be illustrated to be included in the identification table, but the scope of the present disclosure may not be limited thereto. For example, the session key field (f4) may not be included in the identification table, and a new session key may be generated and provided on the spot whenever receiving each protocol request.

Referring back to FIG. 5, the user terminal 300 may access the server apparatus by using the transmitted address information of Internet resource (i.e., the second URL) and the session key. Herein, the server apparatus may be the Internet resource apparatus 400. Alternatively, the server apparatus may be a service server 100 including the Internet resource apparatus 400 in the form of a hardware module and/or a software module. The server apparatus may validate that the user terminal 300 is a valid user by validating a session key, and may provide product or service information to the user terminal 300 or provide an interface for ordering a product or service, when the user is a valid user. The user terminal 300 may transmit a desired product and service ordering to the server apparatus using the provided information or interface, and the server apparatus may process the transmitted ordering.

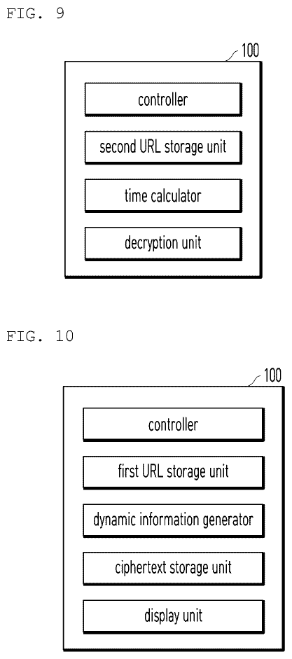

FIG. 8 is a flowchart showing a method for providing ordering information by using dynamic information according to a first exemplary embodiment of the present disclosure. The exemplary embodiment of FIG. 8 may illustrate the operation method described in FIG. 7 in the form of a flowchart.

In the step S11, the ordering terminal 200 may generate the dynamic information.

In the step S12, the ordering terminal 200 may display the generated dynamic information in the form of a QR code or transmit the generated dynamic information in the form of NFC information.

In the step S13, the user terminal 300 may obtain the dynamic information by photographing or scanning the QR code displayed by the ordering terminal 200 or by receiving the NFC information transmitted by the ordering terminal 200.

In the step S14, the user terminal 300 may transmit a protocol request to the apparatus 100 providing the ordering information by using the obtained dynamic information.

In the step S15, the service server 100 may parse the dynamic information in response to the protocol request of the user terminal 300.

In the step S16, the service server 100 may obtain an instant ciphertext from the dynamic information.

In the step S17, the service server 100 may validate the effectiveness of the instant ciphertext. Specifically, the service server 100 may obtain a timestamp at that time when receiving a protocol request, generate one or more reference ciphertexts on the basis of the obtained timestamp and a plurality of pre-shared secret keys, and check whether one or more of the reference ciphertexts match the instant ciphertext, thereby validating the effectiveness of the instant ciphertext. In the step S18, the service server 100 may query an address information of Internet resource (i.e., the second URL) corresponding to the corresponding instant ciphertext when the instant ciphertext is valid, from the identification table. On the other hand, when the instant ciphertext is not valid, the service server 100 may reject or ignore the protocol request of the user terminal 300.

In the step S19, the service server 100 may determine a session key corresponding to the address information of Internet resource.

In the step S20, the service server 100 may provide the queried address information of Internet resource and the determined session key to the user terminal 300.

In the step S21, the user terminal 300 may access the server apparatus by using the provided address information of Internet resource and session key to request a service. Herein, the server apparatus may be the Internet resource apparatus 400 or a service server 100 including the Internet resource apparatus 400.

In the step S22, the server apparatus may validate the effectiveness of the session key.

In the step S23, the server apparatus may provide the ordering information to the user terminal 300 when the session key is valid. On the other hand, when the session key is not valid, the server apparatus may reject or ignore the service request of the user terminal 300.

In the step S24, the user terminal 300 may display the provided ordering information to the user, and may transmit an ordering request to the server apparatus according to a subsequent user input.

In the step S25, the server apparatus may process the transmitted ordering request.

According to the first exemplary embodiment of the present disclosure described so far, the user may easily request untact ordering by using an ordering terminal provided in a store, and it may be possible to effectively prevent an unauthorized third party from requesting the an ordering by validating effectiveness of each request through an instant ciphertext included in the dynamic information. In addition, the ordering terminal may by itself generate the dynamic information that varies over time without relying on external devices, thereby providing dynamic information different from each other for each customer even when there is no a network connection between the ordering terminal and a relay device or when the ordering terminal does not receive new dynamic information updates from the relay device. In addition, there is no need for a gateway for connecting an ordering terminal to a relay device, such that the cost required for constructing an entire service system can be reduced and system construction and maintenance can be made easier.

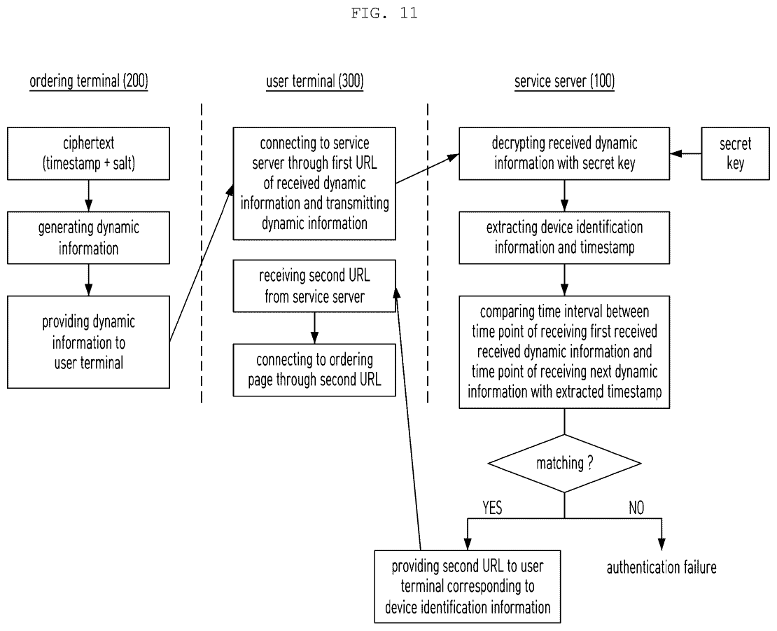

FIGS. 9 to 15 are views showing a method and an apparatus for providing ordering information by using dynamic information according to a second exemplary embodiment of the present disclosure.

In the second exemplary embodiment of the present disclosure, the ordering terminal 200 may store ciphertexts for a predetermined period of time, for example, N years, in a storage in advance, and when updating the dynamic information, may select ciphertexts corresponding to time information (for example, the current time or a timestamp of the current time) obtained from a timer of the ordering terminal 200 among the ciphertexts stored in the storage, and then generate new dynamic information by using the same. This may be in contrast to the first exemplary embodiment above, where an instant ciphertext is generated in real time by operating an encryption algorithm on the spot when updating the dynamic information.

FIG. 9 is a block diagram exemplarily showing a detailed configuration of a service server 100 according to a second exemplary embodiment of the present disclosure. Referring to FIG. 9, the service server 100 may include a controller, a second URL storage unit, a time calculator, and a decryption unit. Some components of the server 100 for providing ordering information shown in FIG. 9 may be software modules, but are not limited thereto.

The controller may control the overall operation of the service server 100. For example, the controller may control the calling and operation of functions for driving other components of the service server 100, or may control the operation of various components included in the service server 100, such as a CPU, a memory, a communication device, etc.

The second URL storage unit may store one or more second URLs to be provided in response to the protocol request of the user terminal 300.

The time calculator may measure time by using a timer module embedded in the service server 100.

As an exemplary embodiment, the time calculator may be configured to calculate a time interval that varies according to each time interval based on a predetermined time interval.

The decryption unit may store the secret key in advance, and may serve to determine whether the dynamic information transmitted by the user terminal 300 is valid on the basis of the stored secret key and the time information provided by the time calculator.

In addition, although not shown, the database may store an identification table including a plurality of address information of Internet resource. The identification table may be used for the service server 100 to query the address information of Internet resource (i.e., the second URL) to be replied to the user terminal 300. For example, when a protocol request is received from the user terminal 300, the server 100 for providing ordering information may query the address information of Internet resource by referring to the identification table stored in the database and provide the same to the user terminal 300.

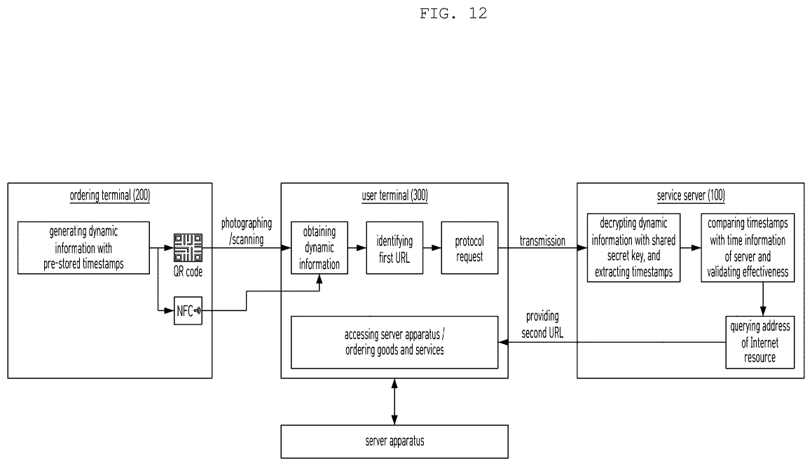

FIG. 10 is a block diagram exemplarily showing a detailed configuration of an ordering terminal 200 according to a second exemplary embodiment of the present disclosure.

The ordering terminal 200 may be a terminal for an ordering provided in a store or the like, and may be a terminal that places an order from a user for a service provided in the store through a means such as a touch, keyboard input, etc.

Referring to FIG. 10, the ordering terminal 200 may include a controller, a first URL storage unit, dynamic information generator, a ciphertext storage unit, and a display unit.

The ciphertexts, where the timestamp and salt value of a predetermined period of time (e.g., N years) are encrypted, may be generated in advance when producing the ordering terminal 200 in the factory or before/after being placed in the store after production, and the ordering terminal 200 may store the same in a memory (or ciphertext storage unit) of the ordering terminal 200. In this case, the ciphertexts of the predetermined period of time may be generated in an external device of the ordering terminal 200 and embedded in the memory of the ordering terminal 200, or the ordering terminal 200 may generate by itself the ciphertexts of the predetermined period of time by using its own encryption algorithm in advance and store the same in the memory. When the ordering terminal 200 generates the ciphertexts by itself, the ordering terminal 200 may include a module for calculating a timestamp and a salt value, an encryption algorithm, and a secret key. Some components of the ordering terminal 200 shown in FIG. 10 may be software modules, but are not limited thereto.

Referring to FIG. 10, the controller may control the overall operation of the ordering terminal 200. For example, the controller may control the calling and operation of functions for driving other components of the ordering terminal 200, or may control the operation of general components included in the ordering terminal 200, such as a CPU, a communication device, etc.

The first URL storage unit may store a first URL for accessing the service server 100, and the dynamic information generator may combine the first URL and the ciphertext and may generate the dynamic information including the same. The generated dynamic information may be generated in the form of a QR code and displayed as a QR code image on the display unit. Alternatively, the generated dynamic information may be generated in the form of NFC information and may be transmitted to the user terminal 300 via the NFC tag.

The ciphertext storage unit may store ciphertexts of a predetermined period of time, for example, N years, that is pre-stored in memory. Each of the ciphertexts may be obtained by encrypting together with a salt value a timestamp corresponding to a time value different from each other among time values (e.g., a specific time or time interval) belonging to the predetermined period of time.

The display unit may be a configuration for externally displaying the dynamic information generated by the dynamic information generator in the form of a QR code image, and may include any one of various display means such as a liquid crystal display (LCD), a light emitting diode (LED), an organic light emitting diode (OLED), an E-paper, and the like.

Meanwhile, although not shown in FIG. 10, the ordering terminal 200 may further include an NFC tag (not shown) for transmitting the dynamic information in the form of NFC information.

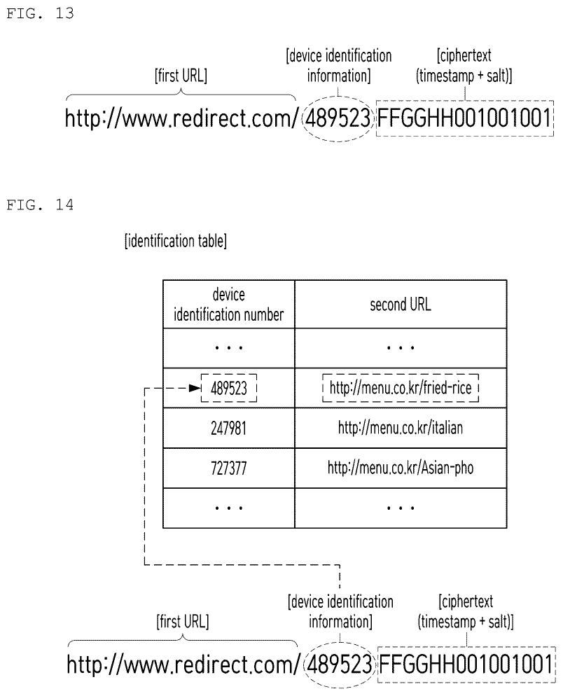

FIGS. 11 and 12 are views for additionally illustrating a method for providing ordering information by using dynamic information in detail according to a second exemplary embodiment of the present disclosure.

Referring to FIGS. 11 and 12, the ordering terminal 200 may select a ciphertext corresponding to the current time among the ciphertexts stored in the ciphertext storage unit. Then, the dynamic information may be generated by combining the first URL, the device identification information of the ordering terminal 200, and the selected ciphertext by using the dynamic information generator, and the generated dynamic information may be provided to the user terminal 300. As described above, the dynamic information may be provided as a QR code image or may be provided as NFC information by using an NFC communication standard.

As an exemplary embodiment, the ordering terminal 200 may update the dynamic information through regenerating the dynamic information according to time, events, or situations. In this case, the ordering terminal 200 may identify the current time at the time of updating the dynamic information, and may allow the regenerated dynamic information to include a ciphertext corresponding to the current time.

For example, suppose that the ciphertexts stored in the ordering terminal 200 includes a first ciphertext including a first timestamp corresponding to the time interval from 00:00:00 to 00:00:10, a second ciphertext including a second timestamp corresponding to the time interval from 00:00:10 to 00:00:20, and a third ciphertext including a third timestamp corresponding to the time interval from 00:00:20 to 00:00:30. At this time, assuming that the update condition of the dynamic information is to automatically update periodically at a time interval of 10 seconds, the ordering terminal 200 may periodically update the dynamic information in order to allow the dynamic information to include a timestamp corresponding to each time interval, through generating the first dynamic information including the first ciphertext at the initial time point 00:00:00, updating the first dynamic information to the second dynamic information including the second ciphertext at the time point 00:00:10 when 10 seconds have elapsed, and then updating the second dynamic information to the third dynamic information including the third ciphertext at the time point 00:00:20 when 10 seconds have elapsed.

Meanwhile, the ciphertext, where a timestamp and a salt value may be encrypted, may be a ciphertext generated by inputting a string combining a timestamp value corresponding to a specific time or time interval and a randomly generated salt value as an input value of an encryption algorithm according to a preset encryption algorithm. In this case, the encryption algorithm may be an encryption algorithm based on two-way encryption using the secret key of the ordering terminal 200 as an encryption key.

Meanwhile, the dynamic information according to the second exemplary embodiment may be updated to include a timestamp that continuously varies according to the current time, so it may be possible to prevent a third party using the past dynamic information stored in advance from accessing the service server 100. That is, the timestamp included in the past dynamic information may correspond to the past time point and may not match the current time point, such that a request based on the past dynamic information may be viewed as an abnormal request and rejected.

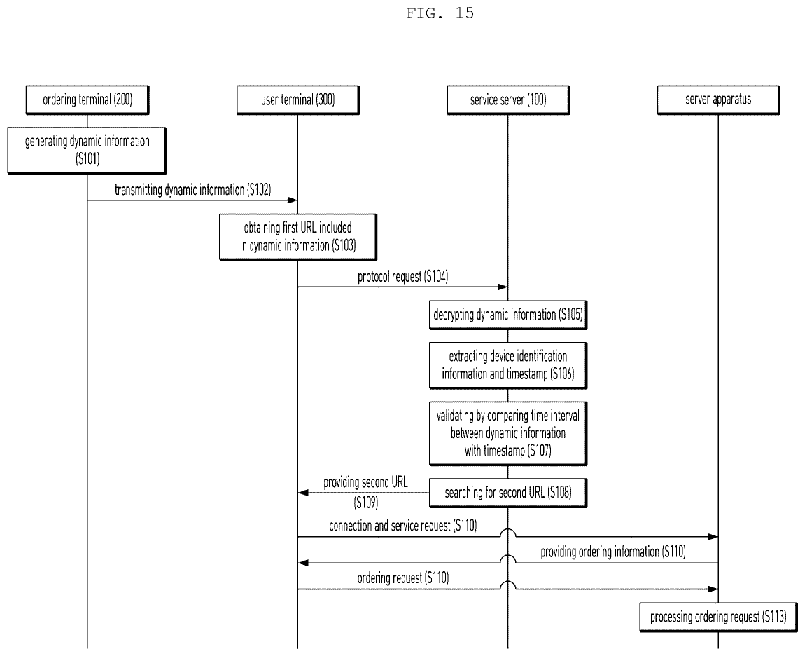

An exemplary form of the dynamic information according to the second exemplary embodiment may be described with reference to FIG. 13. Referring to FIG. 13, when the first URL is “http://www.redirect.com” and the device identification information is “489523”, the ordering terminal 200 may generate the dynamic information of “http://www.redirect.com/489523FFGGHH001001001”, by combining the ciphertext, “FFGH001001001”, generated on the basis of a timestamp and a salt value, the first URL, and the device identification information, and may display the generated dynamic information as a QR code, or transmit the same to the user terminal 300 through NFC.

Even in the second exemplary embodiment, the ordering terminal 200 may not need to receive the dynamic information from the service server 100 for the dynamic information updates. The ordering terminal 200 may generate the time-variable dynamic information through its own embedded module even in a state where there is no communication connection with the service server 100, and accordingly, the ordering terminal 200 may update and provide the dynamic information different from each other at each time, events, or situations without receiving the dynamic information updates from the service server 100.

As described above, the user terminal 300 may scan and recognize a QR code displayed by the display unit of the ordering terminal 200 or may obtain the dynamic information generated by the ordering terminal 200 by communicating with the ordering terminal through NFC 200 (Near Field Communication).

Also, the user terminal 300 may transmit the dynamic information to the service server 100 by transmitting a protocol request to a location specified by the first URL through the first URL included in the obtained dynamic information.

The service server 100 may receive the dynamic information transmitted by the user terminal 300, parse the dynamic information, and extract a device identification number and a ciphertext included in the dynamic information. Then, the ciphertext may be decrypted to extract a timestamp of the dynamic information.

More specifically, the service server 100 may pre-store one or more encryption keys respectively corresponding to one or more ordering terminals. When receiving dynamic information from the user terminal 300, the service server 100 may extract the device identification number and the ciphertext from the received dynamic information. Then, an encryption key corresponding to the device identification information may be selected from one or more encryption keys stored in advance, and the ciphertext extracted from the dynamic information may be decrypted by using the selected encryption key to obtain a decrypted timestamp and salt.

Then, the service server 100 may validate the effectiveness of the dynamic information by comparing the obtained timestamp with time information at the current time. An exemplary method for validating the effectiveness of the dynamic information may be as follows.

Suppose that the service server 100 sequentially receives the first dynamic information and the second dynamic information. In this case, it may be assumed that both the first dynamic information and the second dynamic information are the dynamic information originating from the same ordering terminal 200 and that the first dynamic information is already validated as valid dynamic information.

As an exemplary embodiment, when the first dynamic information is the initial dynamic information originating from the ordering terminal 200, the service server 100 may determine that the first dynamic information is valid without a separate validation of the effectiveness.

When receiving the second dynamic information, the service server 100 may perform to validate the effectiveness of the second dynamic information. To this end, the service server 100 may measure a time interval between a first time point when the service server receives the previous first dynamic information from the user terminal 300 and a second time point when the service server 100 receives the second dynamic information, by using an embedded timer module. Then, the service server 100 may extract device identification information and a ciphertext from the second dynamic information, decrypt the ciphertext by using an encryption key corresponding to the device identification information to obtain a timestamp of the second dynamic information. Then, the effectiveness of the second dynamic information may be validated by comparing the time interval between the first time point and the second time point with the timestamp of the second dynamic information. In this case, when the time interval and the timestamp of the second dynamic information correspond to each other, the second dynamic information may be determined to be valid. For example, when the time value indicated by the timestamp of the first dynamic information is A and the time interval is B, and when the time value indicated by the timestamp of the second dynamic information corresponds to A+B, the timestamp of the second dynamic information may be determined to correspond to the time interval, and the second dynamic information may be also determined to be valid. On the other hand, when the time interval and the timestamp of the second dynamic information do not correspond, for example, when the time value indicated by the timestamp of the second dynamic information does not correspond to A+B, the second dynamic information may be determined to be invalid.

That is, in the exemplary embodiment, the service server 100 may estimate as the current time the time obtained by adding the time interval between the time point of receiving the first dynamic information and the time point of receiving the second dynamic information to the timestamp value of the first dynamic information, and may validate the effectiveness of the second dynamic information by comparing whether the estimated current time and the timestamp of the second dynamic information correspond to each other.

As an exemplary embodiment, when the time interval (or the estimated current time) and the timestamp of the second dynamic information do not correspond to each other, the service server 100 may compare an adjusted time value obtained by reducing the time interval (or the estimated current time) with the timestamp of the second dynamic information, and determine that the second dynamic information is valid when the two correspond to each other.

Like the first exemplary embodiment, this may be for solving the problem that a protocol request is delayed and received by the service server 100 and the effective time of a timestamp elapses even when the protocol request is a normal request using the ordering terminal 200. In this case, the service server 100 may firstly compare the time interval with the timestamp of the second dynamic information, but when both do not correspond to each other, may secondarily compare the adjusted time value with the timestamp of the second dynamic information, thereby complementing the determination error when the protocol request is delayed and received.

Meanwhile, when it is determined that the dynamic information is valid, the service server 100 may provide the address information of Internet resource (i.e., the second URL) corresponding to the received dynamic information to the user terminal 300. The user terminal 300 may receive the address information of Internet resource provided by the service server 100 in response to the protocol request, and may transmit a service request for untact ordering by accessing an ordering page of a first location specified by the address information of Internet resource. Herein, the first location may be a location of a server apparatus, which processes a service request of the user terminal 300, on the Internet network and the server apparatus may be the Internet resource apparatus 400 or the service server 100 including the Internet resource apparatus 400.

The user terminal 300 may receive the ordering information provided by the server apparatus in response to the service request, display the same to the user, and execute untact ordering for a product or service according to a user input therefor.

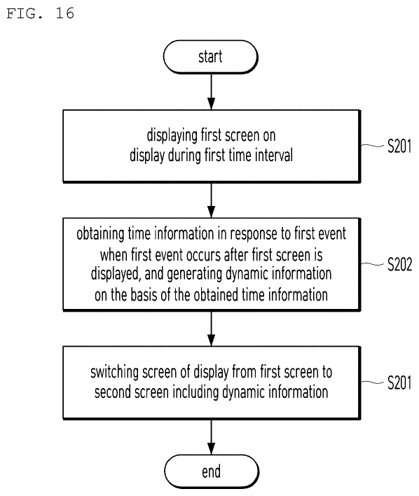

Meanwhile, in order to determine the address information of Internet resource to be provided to the user terminal 300, the service server 100 may use an identification table indicating a correspondence relationship between the device identification information and the second URL. This will be described further with reference to FIG. 14.

Referring to FIG. 14, the service server 100 according to the second exemplary embodiment of the present disclosure may search for a row, where a value identical to the device identification number extracted from the dynamic information by referring to the device identification number field of the identification table is located, referring to a predetermined identification table, may query the second URL in the searched row, and provide the second URL to the user terminal 300 as the address information of Internet resource.

The second URL may be for indicating an address on the Internet network of the server apparatus that provides ordering information to the user terminal 300 and processes an ordering request from the user terminal 300, and may include a homepage and an ordering page operated in a store where the user terminal 300 wants to place an order.

Meanwhile, the identification table may include a plurality of second URLs corresponding to a plurality of stores, and the service server 100 may transmit the second URL of a store different from each other to the user terminal 300 according to the received dynamic information. This may enable the service server 100 to effectively manage untact orderings of a plurality of stores.

In addition, since the service server 100 provides a corresponding URL according to the device identification number included in the dynamic information, there may be no need to receive information on the user's current location from the user terminal. For example, since being aware of which ordering terminal 200 the corresponding dynamic information originates from by simply checking the device identification information, the service server 100 may accurately specify the URL of the ordering page (i.e., the second URL) of the store where the corresponding ordering terminal 200 is placed and may provide the same to the user terminal 300.

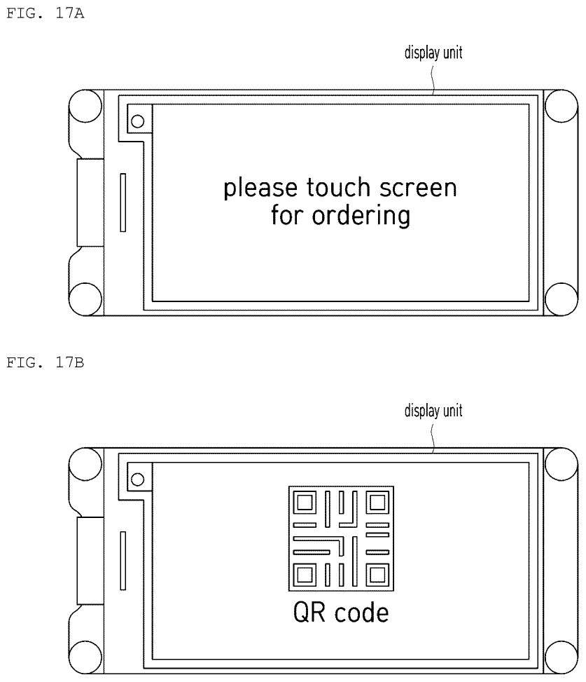

FIG. 15 is a flowchart showing a method for providing ordering information by using dynamic information according to a second exemplary embodiment of the present disclosure.

In the step S101, the ordering terminal 200 may generate the dynamic information.

In the step S102, the ordering terminal 200 may provide the generated dynamic information to the user terminal 300.

In the step S103, the user terminal 300 may obtain a first URL included in the provided dynamic information.

In the step S104, the user terminal 300 may transmit a protocol request to the service server 100 by using the first URL.

In the step S105, the service server 100 may decrypt the ciphertext of the received dynamic information.

In the step S106, the service server 100 may extract the device identification information, decrypt the ciphertext of the dynamic information with an encryption key corresponding to the device identification number, and extract a timestamp of the dynamic information.

In the step S107, the service server 100 may calculate a time interval between the received dynamic information and the previous dynamic information, and may validate the effectiveness by comparing the calculated time interval with the timestamp of the received dynamic information.

In the step S108, when it is determined that the received dynamic information is valid, the service server 100 may search the identification table for an address information of Internet resource (i.e., a second URL) corresponding to the received dynamic information. On the other hand, when it is determined that the received dynamic information is invalid, the service server 100 may reject or ignore the protocol request of the user terminal 300.

In the step S109, the service server 100 may provide the searched address information of Internet resource (i.e., the second URL) to the user terminal 300.

In the step S110, the user terminal 300 may access the server apparatus and transmit a service request by using the address information of Internet resource. Herein, the server apparatus may be the Internet resource apparatus 400 or a service server 100 including the Internet resource apparatus 400.

In the step S111, the server apparatus may provide ordering information to the user terminal 300 in response to the service request.

In the step S112, the user terminal 300 may transmit an ordering request to the server apparatus.

Meanwhile, as described above, the ordering terminal 200 may display the dynamic information in the form of a QR code image, and may be equipped with a display for doing so.

As an exemplary embodiment, the display may be composed of any one of a liquid crystal display (LCD), a light emitting diode (LED), an organic light emitting diode (OLED), an electronic paper, an electrowetting display, a memory LCD, an interferometric modulator display, or a combination thereof, but is not limited thereto.

As an exemplary embodiment, the display may operate through displaying a default screen while the user is not using the ordering terminal 200, and displaying the dynamic information only when the user uses the ordering terminal 200.

In this case, the default screen may be a screen where predetermined characters or images are displayed, and may be a screen for displaying a guiding message in order to help users use untact ordering.

As an exemplary embodiment, the ordering terminal 200 may control the display and/or the power circuit therefor, such that power is temporarily applied to the display only when changing from one screen to another screen, and power is not applied to the display while maintaining the existing screen.

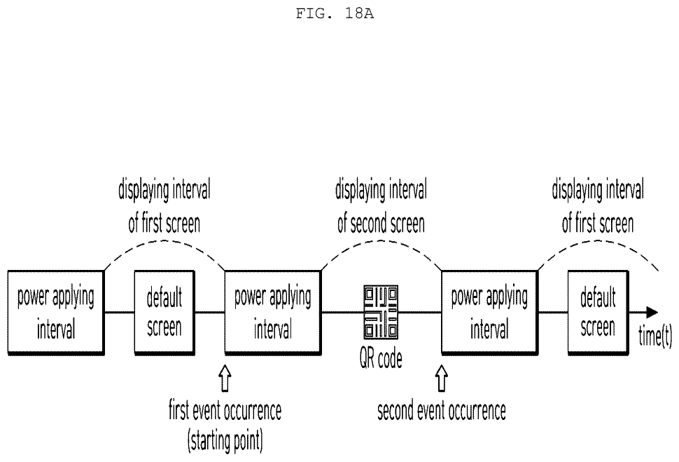

A detailed description related to this will be described with reference to FIG. 16.

FIG. 16 is a flowchart specifically illustrating a method for controlling an operation of a display in order for an ordering terminal 200 to display dynamic information. The method of FIG. 16 may be performed by the ordering terminal 200 of FIG. 1. Therefore, when the performing entity is omitted from the following steps, it may be assumed that the performing entity is the ordering terminal 200.

In the step S201, a first screen may be displayed on the display during a first time interval.

At this time, the first screen may be a default screen including a predetermined characters or image, and the predetermined characters or images may be a guiding message (e.g., “touch the screen for an order”) for helping users use untact ordering.

As an exemplary embodiment, the first time interval may include an activation interval where power is temporarily applied to the display in order to switch to the displaying of the first screen, and a deactivation interval where the displaying of the first screen is maintained in a state where power is not applied to the display. Herein, the activation interval may refer to an interval where power is applied to the display, and the deactivation interval may refer to an interval where power is not applied to the display.

To this end, the display may include a display device capable of maintaining a fixed screen display in a state where power is not applied. For example, the display may be configured to display a QR code image on a screen by moving an electronic ink containing black particles and white particles by using an electric field, and may be configured to include electronic paper (or E-paper).

Electronic paper may be a display means made to display text or images electronically by imitating paper and ink, and display the screen by using reflected light like regular paper, unlike liquid crystal displays (LCDs) and organic light-emitting diodes (OLEDs) that light-emitting devices. Electronic paper may consume power only when switching or changing the screen, and may not require power for maintaining the currently displayed screen.

In this case, the power consumption of the display may be dramatically reduced because power needs to be applied to the display in an interval where the screen of the display is switched to the first screen during the first time interval, and power does not need to be applied in an interval where the display of the first screen is maintained.

In the step S202, when a first event occurs after the first screen is displayed, the time information (e.g., a timestamp) may be obtained in response to the first event, and the dynamic information may be generated on the basis of the obtained time information.

Herein, the first event may be an event that initiates a screen transition, such that a screen of the display switches from a previous first screen (i.e., a default screen) to a second screen where the dynamic information is displayed, and may include, for example, receiving a predetermined user input (e.g., touching the screen, etc.) through a user interface provided in the ordering terminal 200, waking up the ordering terminal 200 on the basis of a predetermined condition (e.g., the end of a break time, etc.), or receiving an activation request for the display from the outside (e.g., a router in a store or an administrator device).

As an exemplary embodiment, when the first event occurs, the ordering terminal 200 may obtain the current time information and generate the dynamic information corresponding thereto according to the obtained time information in order to provide the time-variable dynamic information to the user.

Specifically, the ordering terminal 200 may obtain the time information from the time calculator in order to generate the dynamic information, generate or determine a ciphertext corresponding to the time information on the basis of the obtained time information, and then generate the dynamic information including the ciphertext through combining the ciphertext and the first URL.

At this time, the ciphertext may be generated through generating an instant ciphertext corresponding to the time information by inputting the obtained time information into a predetermined encryption algorithm, or through selecting a ciphertext corresponding to the obtained time information from one or more ciphertexts obtained by encrypting timestamps of a predetermined time.

After generating the dynamic information, the method may proceed to the step S203.

In the step S203, the screen of the display may be switched to the second screen including the dynamic information. In this case, power may be temporarily supplied to the display during the second time interval in order to switch from the first screen to the second screen. Then, power may not be applied to the display again after the switching to the second screen is completed.

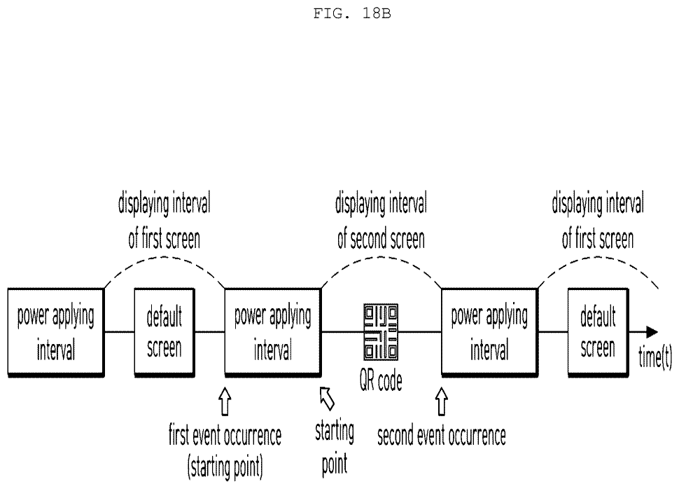

As an exemplary embodiment, the dynamic information may be displayed in the form of a QR code on the second screen. An exemplary form thereof may be shown in FIGS. 17A and 17B. FIG. 17A may show an exemplary form of a first screen that is a default screen, and FIG. 17B may show an exemplary form of a second screen where the dynamic information is displayed as a QR code.

The first screen as shown in FIG. 17A may be displayed during the first time interval and the display of the first screen may be maintained even though power is not applied to the display. Thereafter, when a first event occurs (for example, a user touches a screen), the dynamic information corresponding to the current time may be generated, and power may be applied to the display during a second time interval in order to display the dynamic information on the display. Then, the screen of the display may be switched from the first screen to the second screen by using the applied power. The dynamic information generated on the basis of time information may be displayed on the switched second screen.

As an exemplary embodiment, the second screen may sequentially display dynamic information having values different from each other according to a predetermined period. For example, when each dynamic information is set to be updated every 5 seconds, the second screen may initially display a first dynamic information having a first value, and then change the same to and display a second dynamic information having a second value at a time point when 5 seconds elapses, thereby periodically and sequentially displaying dynamic information of different values. In this case, power may be temporarily supplied to the display in order to change to and display the second dynamic information. Herein, the meaning of the “change and display” may be to replace the previously displayed dynamic information with new dynamic information and displaying the same.

Meanwhile, the case where the dynamic information of different values to each other are periodically “changed and displayed” may be exemplified above, but the scope of the present disclosure may not be limited thereto. For example, the second screen may initially display the first dynamic information, newly calculate the second dynamic information when a predetermined period elapses, and display the calculated second dynamic information together with the first dynamic information (e.g., by displaying the first dynamic information and the second dynamic information in parallel), thereby periodically displaying dynamic information of different values to each other in sequence.

As an exemplary embodiment, when a predetermined second event occurs after switching to the second screen, the screen of the display may be changed back to the first screen, which is the default screen. In this case, the second event may be that a predetermined time (or a reference time) elapses from a predefined starting point.

The present exemplary embodiment may be to further minimize power consumption of the ordering terminal 200. For various purposes, the dynamic information may be updated while the dynamic information is displayed on the second screen. For example, the dynamic information may be updated periodically/aperiodically when each dynamic information is predetermined to be valid only for a limited amount of time for security reasons, or when the dynamic information is to display values that fluctuate from time to time (for example, when a current indoor temperature or a temporary advertising phrase is displayed in the form of the dynamic information).

In order to update such dynamic information, power should be applied to the display whenever an updated value of the dynamic information is displayed, and the process of repeating this may result in continuous power consumption. Therefore, in the present exemplary embodiment, the power consumption of the display may be further minimized by switching again the screen of the display to the default screen, assuming that the dynamic information is displayed for a sufficient time after a certain period of time elapses since switching to the second screen.

As an exemplary embodiment, the predefined starting point may be a time point when the first event occurs, a time point when the screen of the display is switched to the second screen, or a time point when a third event occurs. In this case, the third event may be that a predetermined number of screen switches occur after the first event occurs.

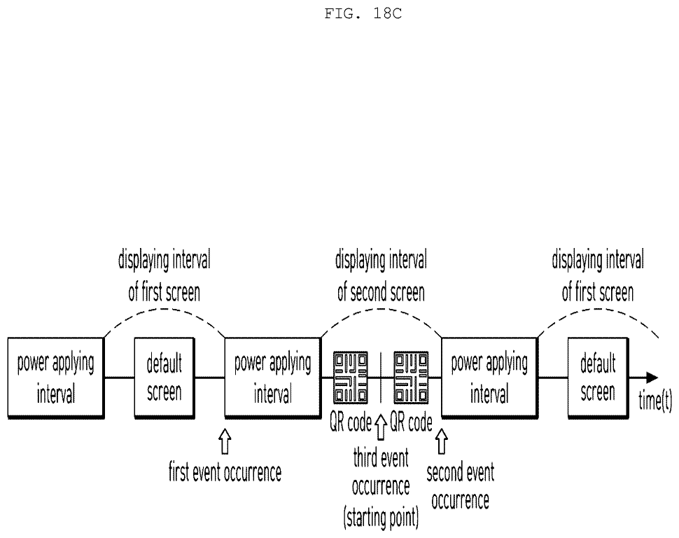

For further explanation, refer to FIGS. 18A to 18C. Various examples of the starting point are shown in the drawings. Herein, it may be assumed that a reference time for triggering the second event is 5 minutes. In this case, the second event occurs when 5 minutes elapses from the starting point.

FIG. 18A may show an exemplary embodiment where the time point of the first event occurrence is the starting point. When the user touches a screen of the display (a first event occurs), power may be applied to the display and the dynamic information corresponding to the current time information may be generated and displayed in the form of a QR code on the second screen. Thereafter, the second screen may be maintained in a state where power is not applied to the display.

In this case, the elapsed time may be calculated by assuming the time point of the first event occurrence as the starting point. Then, when 5 minutes, which is a reference time, elapses from the corresponding starting point, a second event may occur and accordingly, the display may be switched to the first screen, which is a default screen.

FIG. 18B may show an exemplary embodiment where a time point when the screen of the display is switched to the second screen is a starting point. Similar to the previous example, when the user touches the screen of the display (a first event occurs), power may be applied to the display and the dynamic information corresponding to the current time information may be generated and displayed in the form of a QR code on the second screen. Thereafter, the second screen may be maintained in a state where power is not applied to the display.

In this case, the elapsed time may be calculated by assuming the time point, when the switching to the second screen is completed, as the starting point. The time point when the switching to the second screen is completed may be a time point when the temporary power supply for displaying the second screen ends. Then, when minutes 5 elapses the from corresponding starting point, a second event may occur, power may be applied again to the display, and the display may be switched to the first screen, which is the default screen.

FIG. 18C may show an exemplary embodiment where a time point when a predetermined number of times of dynamic information changes occur after the first event occurs is the starting point.

The present exemplary embodiment may describe an example of determining the starting point based on the number of dynamic information changes when one or more dynamic information changes occur during the second screen display interval according to the update period of the dynamic information.

For example, suppose that the predetermined number of times is set to one time. In this case, when the first event occurs, a first QR code may be displayed on the display and the display of the first QR code may be maintained. Thereafter, when the update period of the dynamic information elapses, new dynamic information may be generated and the existing first QR code may be updated to a second QR code including the new dynamic information. In this case, the time point when being updated to the second QR code (that is, the time point at which the number of one dynamic information change is made) may become the starting point, and when 5 minutes elapses on the basis of this, a second event may occur and the display may be switched to the first screen.

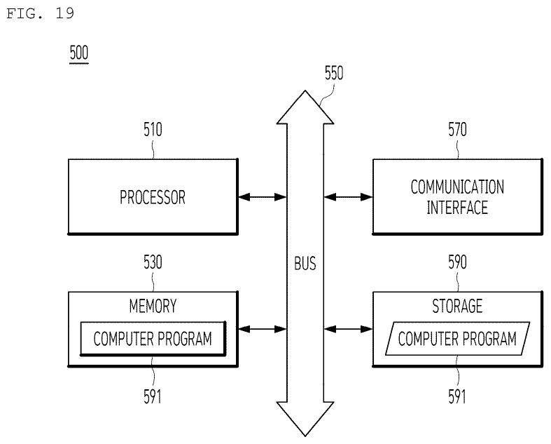

Hereinafter, an exemplary computing apparatus 500 where the methods described in the various exemplary embodiments of the present disclosure are implemented will be described with reference to FIG. 19. For example, the computing apparatus 500 of FIG. 19 may be the service server 100, the ordering terminal 200, or the user terminal 300 of FIG. 1.

FIG. 19 is an exemplary hardware configuration diagram showing a computing apparatus 500.

As shown in FIG. 19, a computing apparatus 500 may include one or more processors 510, a bus 550, a communication interface 570, a memory 591 for loading a computer program 591 executed by the processor 510, and a storage 590 for storing the computer program 591. However, only components related to exemplary embodiments of the present disclosure may be shown in FIG. 19. Accordingly, it may be understood by those skilled in the art that other general components may be further included in addition to the components shown in FIG. 19.

The processor 510 may control the overall operation of each component of the computing apparatus 500. The processor 510 may be configured to include at least one of a central processing unit (CPU), a microprocessor unit (MPU), a micro controller unit (MCU), a graphics processing unit (GPU), or any type of processor well known in the technical field of the present disclosure. In addition, the processor 510 may perform an operation on at least one application or program for executing a method/operation according to various exemplary embodiments of the present disclosure. The computing apparatus 500 may include one or more processors.

The memory 530 may store various types of data, commands, and/or information. The memory 530 may be capable of loading one or more programs 591 from the storage 590 in order to execute methods/operations according to various exemplary embodiments of the present disclosure. An example of the memory 530 may be RAM, but is not limited thereto.

The bus 550 may provide a communication function between components of the computing apparatus 500. The bus 550 may be implemented as various types of buses such as an address bus, a data bus, and a control bus.

The communication interface 570 may support wired/wireless Internet communication of the computing apparatus 500. The communication interface 570 may support various communication methods other than Internet communication. To this end, the communication interface 570 may be configured to include a communication module well known in the technical field of the present disclosure.

The storage 590 may non-temporarily store one or more computer programs 591. The storage 590 may be configured to include non-volatile memory such as read-only memory (ROM), erasable programmable ROM (EPROM), electrically erasable programmable ROM (EEPROM), flash memory, or the like, a hard disk, a removable disk, or any type of computer-readable recording medium well known in the technical field to which the present disclosure pertains.

The computer program 591 may include one or more instructions where the methods/operations according to various exemplary embodiments of the present disclosure are implemented.

For example, when the computing apparatus 500 is a service server 100, the computer program 591 may include instructions for performing an operation of receiving a protocol request together with the dynamic information from a user terminal, an operation of extracting a ciphertext from the dynamic information, an operation of validating the effectiveness of the dynamic information on the basis of the ciphertext, and an operation of providing an address information of Internet resource corresponding to the dynamic information to the user terminal when the dynamic information is valid.

Alternatively, when the computing apparatus 500 is the ordering terminal 200, the computer program 591 may include instructions for performing an operation of generating the dynamic information by combining a ciphertext generated on the basis of time information with a first URL (Uniform Resource Locator), and an operation of generating a QR code on the basis of the dynamic information to display the generated QR code through a display unit or providing the dynamic information to the user terminal by communicating with the user terminal through NFC (Near Field Communication). In this case, the computer program 591 may further include instructions for performing an operation of displaying a first screen including a predetermined character or image on the display unit during a first time interval, the first time interval including an activation interval where power is temporarily applied to the display for switching to the displaying of the first screen and an deactivation interval where the displaying of the first screen is maintained in a state where power is not applied to the display unit, an operation of obtaining the time information in response to a first event when the first event occurs after the first screen is displayed to generate the dynamic information on the basis of the time information, and an operation of switching the screen of the display to a second screen including the dynamic information, wherein power is supplied to the display during a second time interval for switching to the second screen.

As an exemplary embodiment, the user terminal may obtain the dynamic information by scanning a QR code displayed on an ordering terminal or by communicating with the ordering terminal through NFC (Near Field Communication), may transmit the protocol request to a location specified by a first URL (Uniform Resource Locator) of the dynamic information, and may transmit a service request by using an address information of Internet resource provided by a service server in response to the protocol request, wherein the user terminal and the ordering terminal are configured as separate devices.

When the computer program 591 is loaded into the memory 530, the processor 510 may perform methods/operations according to various exemplary embodiments of the present disclosure by executing the one or more instructions.

The technical idea of the present disclosure described so far may be implemented as computer-readable code on a computer-readable medium. The computer-readable recording medium may be, for example, a movable recording medium (CD, DVD, Blu-ray disk, USB storage device, removable hard disk) or a fixed recording medium (ROM, RAM, computer-equipped hard disk). The computer program recorded on the computer-readable recording medium may be transmitted to another computing apparatus through a network such as Internet and may be installed on the other computing apparatus, thereby being used in the other computing apparatus.

Although the exemplary embodiments of the present disclosure have been described with reference to the accompanying drawings, those skilled in the art may understand that the present disclosure may be implemented in other specific forms without changing the technical idea or essential features thereof. Therefore, it should be understood that the exemplary embodiments described above are exemplary and not restrictive in all respects. The scope of protection of the present disclosure should be interpreted by the following claims, and all technical ideas within the equivalent scope should be construed as being included in the scope of the technical idea defined by the present disclosure.

What is claimed is:

1. A method, to be performed by a service server, for providing ordering information by using dynamic information, the method comprising:
receiving a protocol request together with the dynamic information from a user terminal;
extracting a ciphertext from the dynamic information;
validating an effectiveness of the dynamic information on the basis of the ciphertext; and
providing an address information of Internet resource corresponding to the dynamic information to the user terminal when the dynamic information is valid,
wherein the user terminal obtains the dynamic information by scanning a QR code displayed on an ordering terminal or by communicating with the ordering terminal through Near Field Communication (NFC), transmits the protocol request to a location specified by a first Uniform Resource Locator (URL) of the dynamic information, and transmits a service request by using the address information of Internet resource provided by the service server in response to the protocol request,
wherein the user terminal and the ordering terminal is configured as separate devices.

2. The method of claim 1, wherein the ordering terminal is configured to generate the QR code independently of the service server in a state where there is no data communication with the service server.

3. The method of claim 1, wherein the ciphertext is an instant ciphertext generated on the basis of a first timestamp obtained from a timer of the ordering terminal, and
the ordering terminal generates the instant ciphertext by inputting the first timestamp into a predetermined encryption algorithm, and generates the dynamic information on the basis of the generated instant ciphertext.

4. The method of claim 2, wherein the validating the effectiveness of the dynamic information comprises:
obtaining a second timestamp from a timer of the service server;
generating a reference ciphertext on the basis of a secret key corresponding to the ordering terminal and the second timestamp value; and
determining that the dynamic information is valid when the instant ciphertext matches the reference ciphertext.

5. The method of claim 4, wherein the providing the address information of Internet resource to the user terminal
searches for a row, where a value identical to the instant ciphertext is located, referring to a predetermined identification table,
queries a second URL in the searched row, and
provides the queried second URL as the address information of Internet resource to the user terminal.

6. The method of claim 1, wherein the ordering terminal stores in a storage one or more ciphertexts, where one or more timestamps corresponding to time different from each other are respectively encrypted, generating before the dynamic information, selects the ciphertext corresponding to the time information among the one or more ciphertexts on the basis of a time information obtained from a timer of the ordering terminal, and generates the dynamic information by using the selected ciphertext.

7. The method of claim 6, wherein the one or more ciphertexts are encrypted values obtained by inputting strings, where one or more timestamp values corresponding to a predetermined time period are combined with one or more randomly generated salt values, into a predetermined encryption algorithm.

8. The method of claim 1, wherein the validating the effectiveness of the dynamic information comprises:
determining a secret key corresponding to the dynamic information among one or more secret keys stored in advance;
obtaining a timestamp of the dynamic information by decrypting the ciphertext with the determined secret key; and
determining whether the dynamic information is valid by comparing the timestamp with a time information of the service server.

9. The method of claim 8, wherein the determining whether the dynamic information is valid comprises:
calculating a time interval between a first time point when the service server receives a previous dynamic information and a second time point when the service server receives the dynamic information, wherein both the previous dynamic information and the dynamic information originate from the ordering terminal, and the previous dynamic information is received by the service server earlier than the dynamic information; and
determining that the dynamic information is valid when the time interval and the timestamp correspond to each other after comparing the time interval with the timestamp.

10. The method of claim 8, wherein the providing the address information of Internet resource to the user terminal
searches a row, where a value identical to a device identification number of the ordering terminal extracted from the dynamic information is located, referring to a predetermined identification table,
queries a second URL in the searched row, and
provides the queried second URL as the address information of Internet resource to the user terminal.

11. The method of claim 1, wherein the providing the address information of Internet resource to the user terminal includes providing a session key for validating the effectiveness of the service request to the user terminal together with the address information of Internet resource.

12. The method of claim 11, wherein the address information of Internet resource comprises an address on the Internet network of a server apparatus that provides the ordering information to the user terminal and processes an ordering request of the user terminal,
the user terminal presents the session key to the server apparatus in order to prove its access authority to the server apparatus, and
the server apparatus processes the request of the user terminal only when the session key is valid after validating the effectiveness of the session key.

13. A computing apparatus, comprising:
a processor;
a memory for loading a computer program executed by the processor; and
a storage for storing the computer program,
wherein the computer program comprises instructions for performing
an operation of receiving a protocol request together with dynamic information from a user terminal,
an operation of extracting a ciphertext from the dynamic information,
an operation of validating an effectiveness of the dynamic information on the basis of the ciphertext, and
an operation of providing an address information of Internet resource corresponding to the dynamic information to the user terminal when the dynamic information is valid,
wherein the user terminal obtains the dynamic information by scanning a QR code displayed on an ordering terminal or by communicating with the ordering terminal through NFC (Near Field Communication), transmits the protocol request to a location specified by a first URL (Uniform Resource Locator) of the dynamic information, and transmits a service request by using the address information of Internet resource provided by a service server in response to the protocol request,
wherein the user terminal and the ordering terminal is configured as separate devices.

14. An ordering terminal for providing a time-variable dynamic information, the terminal comprising:
a processor;
a memory for loading a computer program executed by the processor; and
a storage for storing the computer program,
wherein the computer program comprises instructions for performing
an operation of generating dynamic information by combining a ciphertext generated on the basis of a time information with a first URL (Uniform Resource Locator), and
an operation of generating a QR code on the basis of the dynamic information to display the generated QR code through a display unit or providing the dynamic information to a user terminal by communicating with the user terminal through NFC (Near Field Communication),
wherein the user terminal obtains the dynamic information from the ordering terminal, transmits a protocol request to a location specified by the first URL of the dynamic information, and transmits a service request by using an address information of Internet resource provided by a service server in response to the protocol request,
wherein the user terminal and the ordering terminal is configured as separate devices.

15. The terminal of claim 14, wherein the computer program further comprises instructions for performing
an operation of displaying a first screen including a predetermined character or image on the display during a first time interval, the first time interval comprising an activation interval where power is temporarily applied to the display for switching to a displaying of the first screen and an deactivation interval where the displaying of the first screen is maintained in a state where power is not applied to the display,
an operation of obtaining the time information in response to a first event when the first event occurs after the first screen is displayed to generate the dynamic information on the basis of the time information, and
an operation of switching the screen of the display to a second screen including the dynamic information, wherein power is supplied to the display during a second time interval in order to switch to the second screen.

16. The terminal of claim 14, wherein the first event comprises at least one of receiving a predetermined user input through a pre-equipped user interface, waking up the display on the basis of a predetermined condition, and receiving an activation request for the display from an external source.

17. The terminal of claim 14, wherein the second screen sequentially displays dynamic information having values different from each other according to a predetermined period.

18. The terminal of claim 14, wherein the computer program further comprises instructions for performing an operation of switching the screen of the display to the first screen when a second event occurs after switching to the second screen.

19. The terminal of claim 18, wherein the second event comprises that a predetermined time elapses from a predefined starting point, and the predefined starting point is one of a time point when the first event occurs, a time point when the screen of the display switched to the second screen, and a time point when the third event occurs.

20. The terminal of claim 19, wherein the third event is that a predetermined number of times of dynamic information changes occur after an occurrence of the first event.
